(19) United States
(12) Patent Application Publication
(10) Pub. No.: US 2026/0254868 A1
(43) Pub. Date: Aug. 27, 2026

(54) DISTRIBUTED AVERAGE CONSENSUS WITH CONNECTED DOMINATING SETS

(71) Applicant: The Government of the United States of America, as represented by the Secretary of the Navy, Arlington, VA (US)

(72) Inventors: Joseph Macker, Washington, DC (US); Kyle Crandall, Washington, DC (US)

(73) Assignee: The Government of the United States of America, as represented by the Secretary of the Navy, Arlington, VA (US)

(21) Appl. No.: 19/345,160

(22) Filed: Sep. 30, 2025

Related U.S. Application Data
(60) Provisional application No. 63/763,582, filed on Feb. 26, 2025.

(51) Int. Cl. H04L 67/10

(52) U.S. Cl. CPC H04L 67/10

(57) ABSTRACT

Systems and methods are provided for using Connected Dominating Sets (CDS) in a Distributed Average Consensus (DAC) process to bridge the gap between a fully centralized consensus approach and a fully distributed one. Embodiments of the present disclosure provide a process for distributed network consensus using network node proxies based on CDS, demonstrating reductions in both the network-wide convergence time and required network communications to achieve agreement. In an embodiment, CDS are used to act as a subgraph of proxy agents for the network iterative communication and computation process, resulting in a network wide DAC result. Embodiments of the present disclosure reduce the required messages and overall delay needed to converge to a distributed group solution.

### CROSS REFERENCE TO RELATED APPLICATIONS

This application claims the benefit of U.S. Provisional Patent Application Number 63/763,582, filed on February 26, 2025, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; nrltechtran@us.navy.mil, referencing Navy Case Number 212366-US2.

### FIELD OF THE DISCLOSURE

This disclosure relates to computer networks, including agent-based networks.

### BACKGROUND

Distributed Average Consensus (DAC) is a networked agent process that uses message passing between agents within a connected graph to calculate a distributed average over the entire collection of agents, without any single agent necessarily being aware of all the relevant datapoints. This mechanism has a range of applications in coordinating data over decentralized communications networks. The key determinant in the performance of a DAC mechanism is the Laplacian matrix of the communications graph. The eigenvalues of this matrix determine how quickly the agents will converge to a consensus.

Some DAC approaches select a single node as the center. Other nodes pass information to the central node, the central node makes calculations, and results are disseminated. Centralized methods are fragile and prone to failure and converge in a single universal exchange of data. Some decentralized methods rely on nodes only interacting with their immediate neighbors. For example, data can be shared with neighbors, and local estimates are updated based on new information. Decentralized distributed methods are more robust than centralized methods but often take longer to reach a consensus. Decentralized methods use an iterative process that eventually converges. Conventional approaches require an undesirably high number of messages and introduce an undesirable amount of delay.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a diagram of an exemplary system using Connected Dominating Sets (CDS) in accordance with an embodiment of the present disclosure;

FIG. 2 is a flowchart of an exemplary node process in accordance with an embodiment of the present disclosure;

FIG. 3A is a block diagram of an exemplary node in accordance with an embodiment of the present disclosure;

FIG. 3B is a block diagram showing two sensors in an exemplary sensor system in accordance with an embodiment of the present disclosure;

FIG. 4 shows results from an exemplary embodiment of the present disclosure; and

FIG. 5 is a chart showing additional results from an exemplary embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### Overview

Embodiments of the present disclosure provide systems and methods for using Connected Dominating Sets (CDS) in a DAC process to bridge the gap between a fully centralized consensus approach and a fully distributed one. Embodiments of the present disclosure provide a process for distributed network consensus using network node proxies based on CDS, demonstrating reductions in both the network-wide convergence time and required network communications to achieve agreement. In an embodiment, CDS are used to act as a subgraph of proxy agents for the network iterative communication and computation process, resulting in a network wide DAC result. Embodiments of the present disclosure reduce the required messages and overall delay needed to converge to a distributed group solution.

### Exemplary Systems

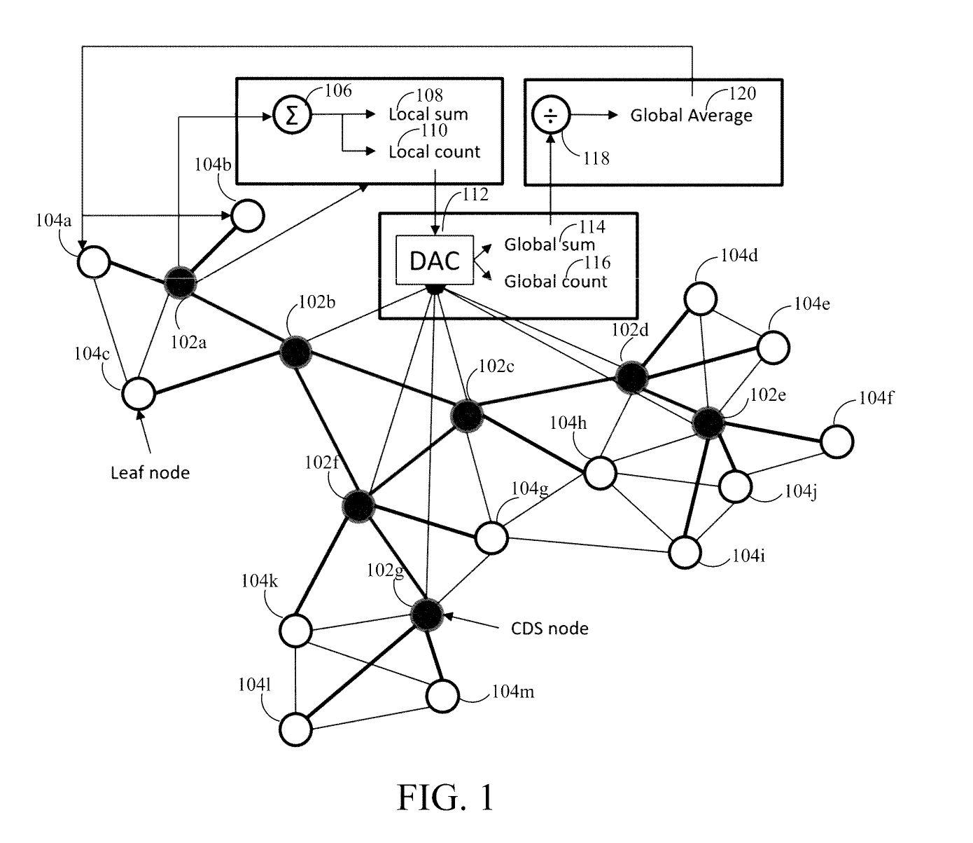

FIG. 1 is a diagram of an exemplary system using Connected Dominating Sets (CDS) in accordance with an embodiment of the present disclosure. FIG. 1 shows a network of a plurality of CDS nodes 102, represented by dark filled circles and a plurality of leaf nodes 104, represented by empty circles. In an embodiment, leaf nodes 104 can share values with the closest CDS node. For example, in an embodiment, leaf node 104a can share its values with CDS node 102a. In an embodiment, leaf nodes 104 wait for updates from CDS nodes 102 with consensus values. In an embodiment, CDS nodes 102 sum 106 values from leaf nodes 104. In an embodiment, CDS nodes 102 compute a local sum 108 and a local count 110. In an embodiment, CDS nodes 102 can then engage in DAC 112 with other CDS nodes 102. In an embodiment, CDS nodes 102 compute a global sum 114 and a global count 116. In an embodiment, CDS nodes 102 can then calculate 118 a global average 120 and can share this global average 120 with leaf nodes 104.

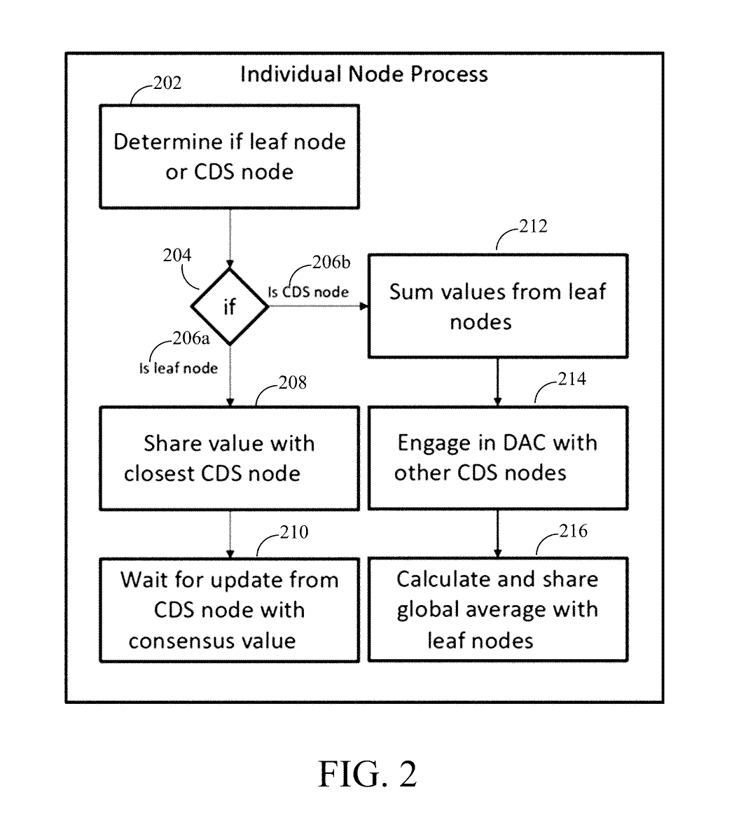

FIG. 2 is a flowchart of an exemplary node process in accordance with an embodiment of the present disclosure. In step 202, a determination is made regarding whether the current node is a leaf node or a CDS node. In step 204, if the current node is a leaf node 206a, the method proceeds to step 208. In step 204, if the current node is a CDS node 206b, the method proceeds to step 212. In an embodiment, steps 202 and 204 are optional, and the current node already knows whether it is a CDS node or a leaf node and performs respective operations for leaf nodes or CDS nodes.

In step 208, the leaf node shares its value with the closest CDS node. For example, in an embodiment, leaf node 104a shares its value (e.g., a value measured by, or monitored by, leaf node 104a and stored in a memory accessible by leaf node 104a) with CDS node 102a. In an embodiment, leaf nodes share their updates at the start of the process (e.g., upon bootup in an embodiment) and then after a predetermined amount of time set by the particular application. In step 210, the leaf node waits for an update from a CDS node with a consensus value. For example, in an embodiment, leaf node 104a waits for an updated global average 120 that is sent to each leaf node 104 after computation.

In step 212, a CDS node sums values from leaf nodes. For example, in an embodiment, CDS node 102a sums values from the leaf nodes that are closest to it, i.e., leaf nodes 104a and 104b. In an embodiment, leaf nodes can be assigned to a CDS node that is not closest to it to balance load among CDS nodes 102. For example, in an embodiment, leaf node 104c is assigned to share its updates with CDS node 102b. In FIG. 1, lines between leaf nodes 104 and their respective CDS nodes 102 are shown with bold lines. In an embodiment, CDS nodes 102 can sum values from respective leaf nodes once each CDS node 102 has received updates from all its assigned leaf nodes. In an embodiment, the leaf nodes assigned to each CDS node 102 are stored in a memory accessible by each CDS node 102.

In step 214, a CDS node engages in DAC with other CDS nodes. For example, in an embodiment, CDS node 102a engages in DAC 112 with other CDS nodes 102. In an embodiment, CDS nodes 102 engage in DAC 112 once all CDS nodes 102 have collected updates from their respective leaf nodes 104. In an embodiment, once CDS nodes 102 engage in DAC 112, DAC 112 is performed by CDS nodes 102 simultaneously until a consensus is reached among CDS nodes 102. In an embodiment, CDS nodes 102 share their respective sums with each other and update their sums based on values shared with them according to DAC 112 and come to a consensus. In step 216, the global average is calculated and shared with leaf nodes. For example, in an embodiment, CDS nodes 102 calculate global average 120 using DAC 112 and, and each CDS node 102 shares global average 120 with its respective leaf nodes 104.

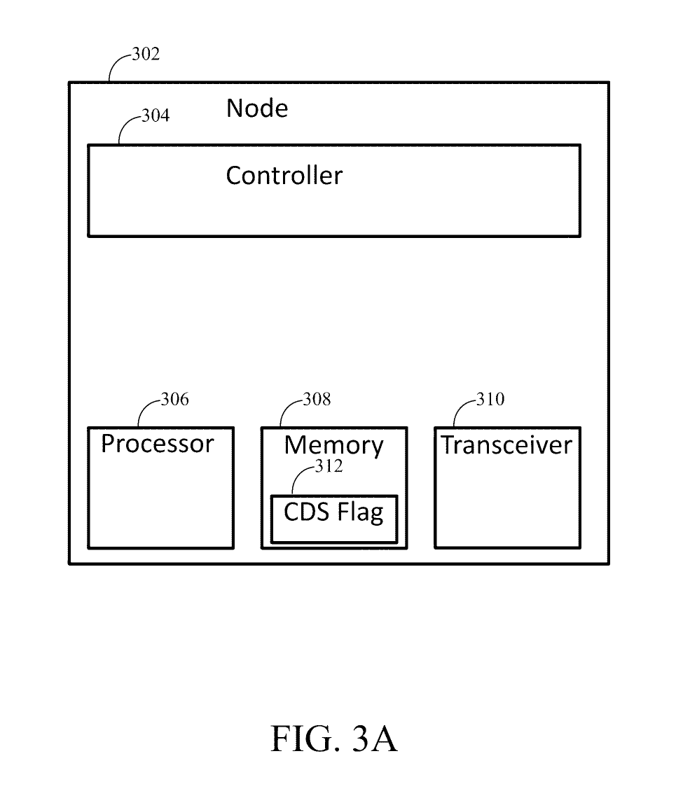

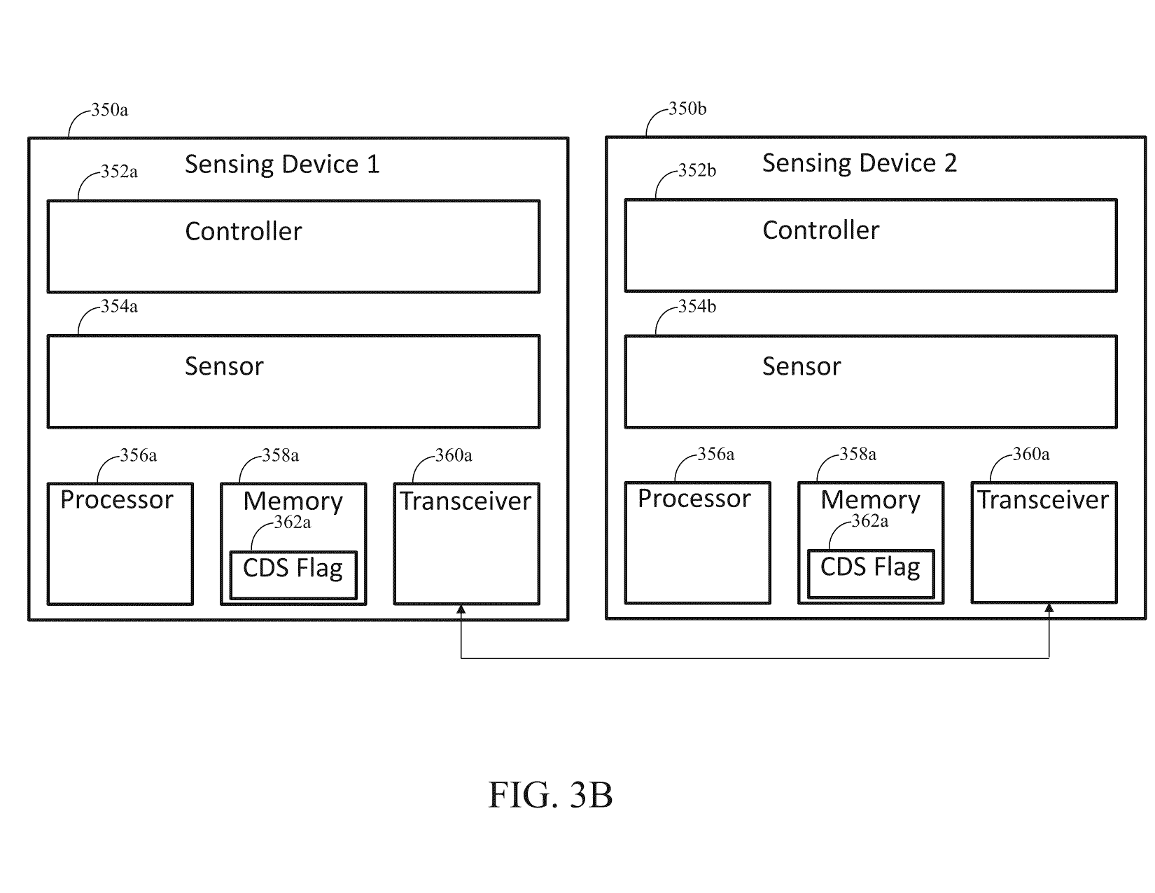

FIG. 3A is a block diagram of an exemplary node in accordance with an embodiment of the present disclosure. In FIG. 3A, in an embodiment, a node 302 has a controller 304, a processor 306, a memory 308, and a transceiver 310. Node 302 can be a leaf node or a CDS node. In an embodiment, memory 308 stores a CDS flag 312 that is true if node 302 is a CDS node and false if node 302 is a leaf node. In an embodiment, nodes can be designated as CDS nodes or leaf nodes depending on the application, and, in an embodiment, CDS flag 312 can change dynamically (e.g., depending on network conditions).

Node 302 can be implemented using hardware, software, and/or a combination of hardware and software in accordance with embodiments of the present disclosure. Node 302 can be implemented as a standalone special purpose device or integrated into a host device in accordance with embodiments of the present disclosure. In an embodiment, if node 302 is integrated into a host device, node 302 may not have processor 306, memory 308, and/or transceiver 310 as part of node 302 but may instead access a processor, memory, and/or transceiver of the host device. In an embodiment, node 302 is a computer. In an embodiment, node 302 is a unmanned aerial vehicle (UAV).

In an embodiment, node 302 is a sensor. In an embodiment, node 302 is a special purpose device for distributed machine learning. For example, in an embodiment, multiple different processing nodes can be located in different physical locations accessing a training database, and nodes can train respective models on local data and then share weights (e.g., using the process of FIG. 2).

FIG. 3B is a block diagram showing two sensors in an exemplary sensor system in accordance with an embodiment of the present disclosure. In FIG. 3B sensing device 1 350a and sensing device 2 350b each have a respective controller 352, sensor 354, processor 356, memory 358, and transceiver 360. In an embodiment, sensing device 1 350a and sensing device 2 350b each have a respective CDS flag 362 stored in each respective memory 358 indicating whether sensing device 1 and/or sensing device 2 is designated as a CDS node. In an embodiment, sensing device 1 350a and sensing device 2 350b communicate via respective transceivers 360.

In an embodiment, sensing device 1 350a and sensing device 2 350b are nodes with different types of sensors, resolutions, and sensing modalities. In an embodiment, sensor 354a and sensor 354b each have different respective sensing modalities and can combine distributions using the method of FIG. 2. For example, in an embodiment sensor 354a and sensor 354b are each different types of sensors configured to measure different physical phenomena in a physical environment surrounding each respective sensing device 350. In an embodiment, using the method of FIG. 2, sensing device 1 350a and sensing device 2 350b can harmonize these different sensor measurements to come to a consensus about the physical phenomena in the physical environment surrounding each respective sensing device 350. While only 2 nodes are shown in FIG. 3B, it should be understood that several additional nodes can be used in a sensing system in accordance with an embodiment of the present disclosure. For example, in an embodiment, the system of FIG. 1A is a sensing system, and sensing device 1 350a and sensing device 2 350b are each nodes in the sensing system of FIG. 1A (e.g., they are each one of either CDS nodes 102 or leaf nodes 104).

### Exemplary Results

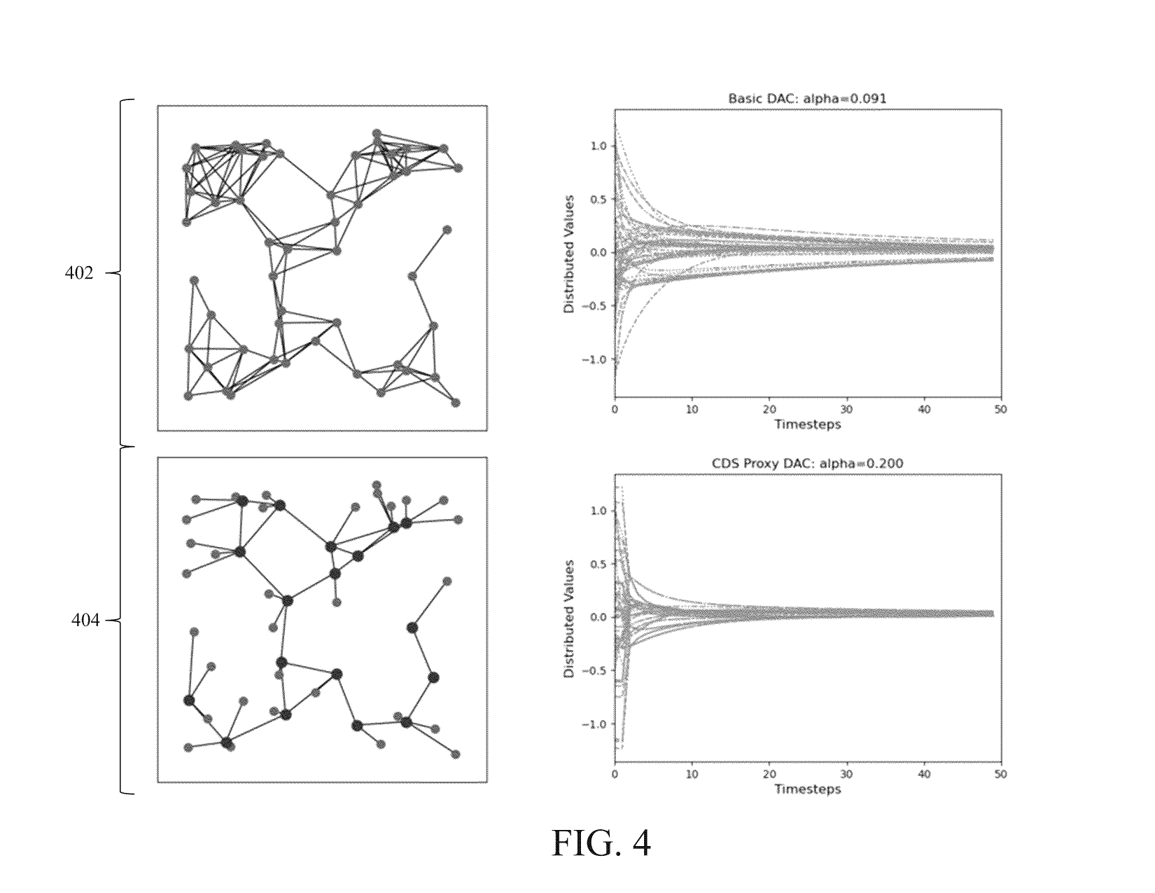

In an embodiment, working prototypes were developed and experiments were conducted to demonstrate value. In an embodiment, an initial single network example is presented here (soft geometric topology example: 50 agents (network size parameter); r = 0.25 (network density parameter)). FIG. 4 shows results from an exemplary embodiment of the present disclosure. In FIG. 4, the top set of graphs 402 show a given network and a conventional DAC process without the CDS proxying mechanisms according to an embodiment of the present disclosure. The bottom set of graphs 404 show the elected CDS proxies in dark circles, the improved convergence times, and final consensus on the right for operations with a CDS mechanism in accordance with an embodiment of the present disclosure.

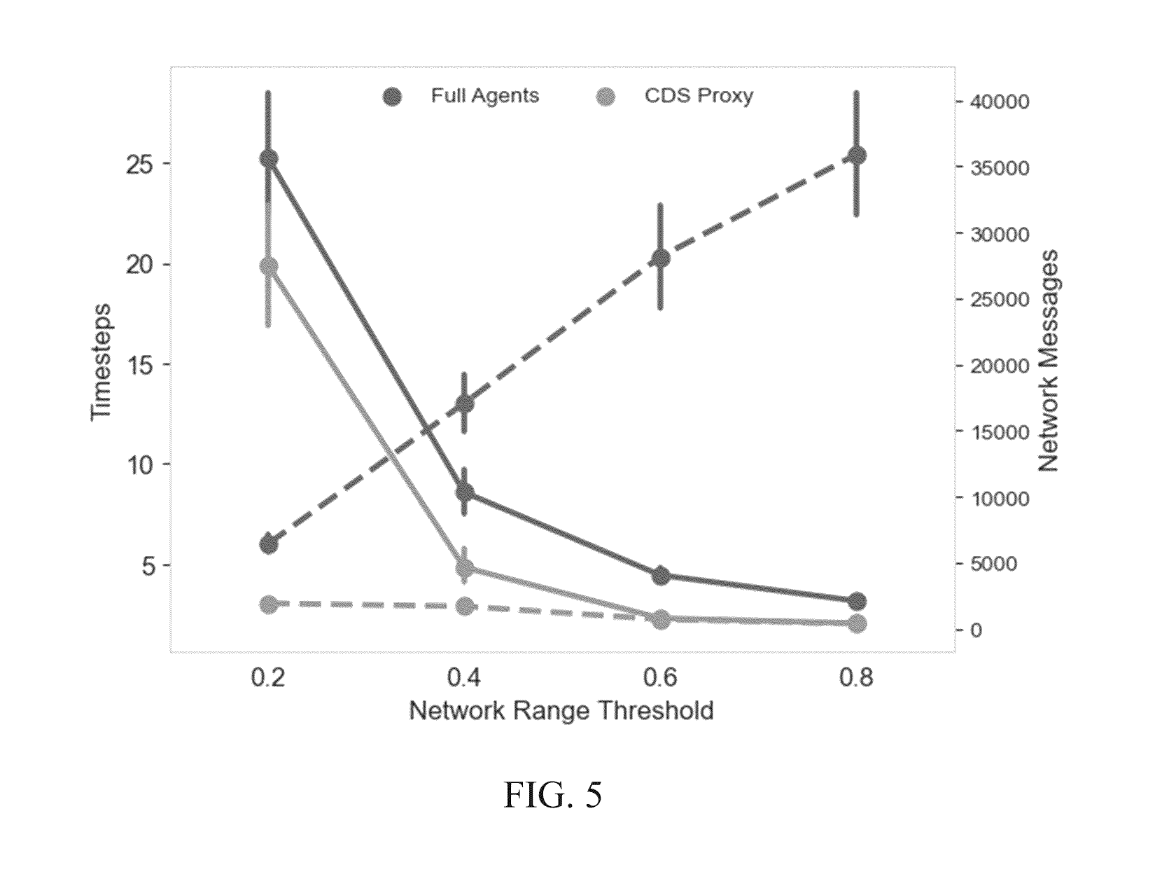

FIG. 5 is a chart showing additional results from an exemplary embodiment of the present disclosure. FIG. 5 shows an aggregate statistical graph demonstrating the process reductions in network overhead messaging and consensus delay enabled by embodiments of the present disclosure. This experimental set includes 800 randomized soft geometric networks with randomized topology (SGN density ranges (x axis): 0.2,0.4,0.6,0.8; Network sizes: 20,30,40,50; and 50 randomized networks for each size and density). Timesteps (y axis) represent the delay to reach an agreement threshold (<0.005).

### Exemplary Advantages

Embodiments of the present disclosure provide systems and methods for a DAC process that uses a CDS mechanism that can have several advantages over using pure DAC methods such as: faster convergence to global consensus, especially on network graphs with a high leaf-to-CDS node ratios; a reduction in required message passing between nodes that results in less overall network traffic, leading to increased performance, especially in cases where there is limited capacity or other network traffic that needs to be considered; and CDS agent mechanisms that require only local knowledge of their values and are directly connected neighbors.

### Conclusion

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Any representative signal processing functions described herein can be implemented using computer processors, computer logic, application specific integrated circuits (ASIC), digital signal processors, etc., as will be understood by those skilled in the art based on the discussion given herein. Accordingly, any processor that performs the signal processing functions described herein is within the scope and spirit of the present disclosure.

The above systems and methods may be implemented using a computer program executing on a machine, using a computer program product, or using a tangible and/or non-transitory computer-readable medium having stored instructions. For example, the functions described herein could be embodied by computer program instructions that are executed by a computer processor or any one of the hardware devices listed above. The computer program instructions cause the processor to perform the signal processing functions described herein. The computer program instructions (e.g., software) can be stored in a tangible non-transitory computer usable medium, computer program medium, or any storage medium that can be accessed by a computer or processor. Such media include a memory device such as a RAM or ROM, or other type of computer storage medium such as a computer disk or CD ROM. Accordingly, any tangible non-transitory computer storage medium having computer program code that cause a processor to perform the signal processing functions described herein are within the scope and spirit of the present disclosure.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A device for determining an updated value using a distributed average consensus (DAC) process, the device comprising:
a processor; and
a controller, wherein the controller is configured to cause the processor to perform operations comprising:
determining if the device is a leaf node,
in response to a determination that the device is a leaf node:
sharing a value with a corresponding non-leaf node, and
receiving the updated value from the corresponding non-leaf node,
in response to a determination that the device is not a leaf node:
summing values received from a plurality of leaf nodes assigned to the device,
engaging in the DAC process with a plurality of other non-leaf nodes,
calculating, with the plurality of other non-leaf nodes, the updated value using the DAC process, and
sending the updated value to the plurality of leaf nodes assigned to the device.

2. The device of claim 1, wherein determining if the first node device is a leaf node comprises:
determining whether the device is a leaf node or a Connected Dominating Sets (CDS) node.

3. The device of claim 2, wherein the device further comprises:
a memory, wherein the memory stores a flag indicating whether the device is a CDS node.

4. The device of claim 1, wherein the corresponding non-leaf node is a Connected Dominating Sets (CDS) node.

5. The device of claim 4, wherein the CDS node is the closest CDS node in a plurality of CDS nodes to the device.

6. The device of claim 1, wherein engaging in the DAC process with other non-leaf nodes comprises:
waiting until all leaf nodes assigned to the device have sent corresponding values to the device before engaging in the DAC process with the other non-leaf nodes.

7. The device of claim 1, wherein the device is a special purpose device for distributed machine learning.

8. The device of claim 1, wherein the device is an unmanned aerial vehicle (UAV).

9. The device of claim 1, wherein the device is a sensor device.

10. The device of claim 9, wherein the device further comprises:
a sensor configured to measure the value in a physical environment surrounding the device using a first sensing modality, wherein the first sensing modality is different from a second sensing modality used by a second device in communication with the device.

11. The device of claim 10, wherein calculating, with the plurality of other non-leaf nodes, the updated value using the DAC process comprises:
calculating the updated value based on the value and a second value measured by the second device using the second sensing modality.

12. A system for determining an updated value using a distributed average consensus (DAC) process, the system comprising:
a leaf node device, comprising:
a first processor, and
a first controller, wherein the first controller is configured to cause the first processor to perform operations comprising:
sending a value, and
receiving the updated value,
a Connected Dominating Sets (CDS) node device, comprising:
a second processor, and
a second controller, wherein the second controller is configured to cause the second processor to perform operations comprising:
summing values received from a plurality of leaf nodes, including the leaf node device, assigned to the CDS node device,
engaging in the DAC process with a plurality of other CDS nodes,
calculating, with the plurality of other CDS nodes, the updated value using the DAC process, and
sending the updated value to the plurality of leaf nodes, including the leaf node device, assigned to the CDS node device.

13. The system of claim 12, wherein the CDS node device further comprises:
a memory, wherein the memory stores a flag indicating that the CDS node device is a CDS node in the plurality of CDS nodes.

14. The system of claim 12, wherein engaging in the DAC process with other non-leaf nodes comprises:
waiting until all leaf nodes assigned to the CDS node device have sent corresponding values to the CDS node device before engaging in the DAC process with the other CDS nodes.

15. The system of claim 12, wherein the CDS node device is a special purpose device for distributed machine learning.

16. The system of claim 12, wherein the CDS node device is an unmanned aerial vehicle (UAV).

17. The system of claim 12, wherein the CDS node device further comprises:
a sensor configured to measure the value in a physical environment surrounding the CDS node device using a first sensing modality, wherein the first sensing modality is different from a second sensing modality used by the leaf node device.

18. A system for determining an updated value using a distributed average consensus (DAC) process, the system comprising:
a leaf node device, comprising:
a first processor,
a first sensor configured to sense, using a first sensing modality, a first value for data in a first physical environment surrounding the leaf node device, and
a first controller, wherein the first controller is configured to cause the first processor to perform operations comprising:
sending the value, and
receiving the updated value,
a Connected Dominating Sets (CDS) node device, comprising:
a second processor,
a second sensor configured to sense, using a second sensing modality different from the first sensing modality, a second value for the data in a second physical environment surrounding the CDS node device, and
a second controller, wherein the second controller is configured to cause the second processor to perform operations comprising:
summing values, including the first value, received from a plurality of leaf nodes, including the leaf node device, assigned to the CDS node device,
engaging in the DAC process with a plurality of other CDS nodes,
calculating, with the plurality of other CDS nodes, the updated value using the DAC process, and
sending the updated value to the plurality of leaf nodes, including the leaf node device, assigned to the CDS node device.

19. The system of claim 18, wherein the leaf node device and the CDS node device are unmanned aerial vehicles (UAVs).

20. The system of claim 18, wherein the leaf node device and the CDS node device are special purpose devices for distributed machine learning.
